(19) United States
(12) Patent Application Publication
(10) Pub. No.: US 2005/0058414 A1
(43) Pub. Date: Mar. 17, 2005

(54) Porous retroreflection suppression plates, optical isolators and method of fabricating same

(75) Inventor: Vladimir Kochergin, Westerville, OH (US)

Correspondence Address: NIXON & VANDERHYE, PC, 1100 N GLEBE ROAD, 8TH FLOOR, ARLINGTON, VA, 22201-4714, US

(73) Assignee: Lake Shore Cryotronics, Inc., Westerville, OH (US)

(21) Appl. No.: 10/923,076

(22) Filed: Aug. 23, 2004

Related U.S. Application Data
(60) Provisional application No. 60/496,687, filed on Aug. 21, 2003.

(51) Int. Cl. G02B 6/08

(52) U.S. Cl. 385/120

(57) ABSTRACT

A plate having leaky waveguides defined therethrough can be used for retroreflection suppression and/or light diffusing/optical isolation. Such designs can exhibit good performance over a wider range of wavelengths and angles of the incident light than current art optical components.

### CROSS-REFERENCES TO RELATED APPLICATIONS

This application claims the benefit of priority from provisional application No. 60/496,687 filed Aug. 21, 2003 (attorney docket no. 340-78), incorporated herein by reference.

### STATEMENT REGARDING FEDERALLY SPONSORED RESEARCH OR DEVELOPMENT

Not applicable.

### FIELD

The technology herein relates to retroreflection suppression plates and optical isolators, and more specifically to retroreflection suppression plates and optical isolators constructed of artificially structured composites containing porous materials. Further, the technology herein relates to light diffusers, more specifically to light diffusers constructed of artificially structured composites containing porous materials.

### BACKGROUND AND SUMMARY

Retroreflection from optical components and/or systems is an important factor for military applications. For example, recent advances in uncooled, long wavelength infrared (LWIR) imaging sensors have enabled their use in many military and civilian applications that require smaller size, lighter weight and lower cost than alternative IR technologies. These sensors are now being considered for many future combat system platforms to meet target acquisition, navigation and surveillance requirements. These sensors are also being used in the commercial marketplace for surveillance and security applications as well. In military applications, it is very important to manage the signature of sensors without compromising performance.

The reflectivity of current uncooled LWIR sensor technology is unacceptably high and compromises their detection by use of continuous wave (CW) or pulsed search lasers. It is desirable to reduce the reflectivity of uncooled imaging sensors by use of optical, electronic, imaging or any other innovative techniques that can be practically integrated into the compact sensor system package. Generally, the angle of incidence of the incoming radiation is changed optically so as to minimize the retroreflection, or the incoming image may be modified by use of optical or image-processing techniques to make it out of focus and then it is re-imaged for display. Novel optical implementations that would enable more compact and secure LWIR sensors are needed.

From another point of view, scattering/diffusion plates are playing important roles in many optical systems. For example, optical elements for diffusing light are typically used for large screen projection TV's. As one example prior art technology, a diffusing optical structure may include a lenticular array consisting of vertically oriented cylindrical lenslets formed in a plastic sheet. Said array distributes the light horizontally by an angular amount determined by the numerical aperture of the individual lenslets. Typical commercially available screens with a lenticular array have poor efficiency (e.g., 30% or less), and have undesirable color banding and white and dark lines at the edges of the pattern due to the diffraction effect of the lenslet array. Often a two-sided lenticular screen is used for projection TV's having a black absorbing stripe between lenslets to increase the screen contrast and reduce ambient room-light reflections. As another example, light diffusion is also used for skylights. Typically, the skylights have a clear windowpane installed at roof level of a room followed by a deep well that is painted white. The deep well acts as a diffusing reflector to prevent direct sunlight from reaching the room. Often when large skylights are used, specially shaped diffusing reflectors are installed. While diffusing reflectors are effective, they are expensive and unaesthetic. Accordingly, it would be desirable to diffuse light from a skylight without the need for a diffusing reflector.

Diffusing of light may also be provided by frosting of glass used for windows, or in the area of artificial light, by the frosting of light bulbs. However, such light diffused through frosted glass is often not as uniform as desired.

In the case of a prior art plate commonly used in, for example, light diffusion, which is made of transparent material having one or both sides randomly corrugated, losses due to the scattering backward direction are unavoidable. In addition, the scattering pattern of the prior art plates is dependent on the incident beam convergence and tilt.

Another prior light diffuser example includes an optical system for diffusing light for use in illumination or display applications having a cascade of a diffractive element, such as a grating, and a thin diffusing element, referred to as a diffuser. Such systems are complicated and not cost effective. In addition to complexity, such systems suffer from back-scattering losses, limiting their performance.

Moreover, the use of diffraction gratings leads to degraded spectral performance (the performance of such diffusers is different for different wavelengths of light). A novel optical design of a light diffuser which could solve the problems described above is needed.

In an additional application area, optical isolators are an important passive optical component in telecommunications, optical sensing and related technologies. The function of an optical isolator is to let a light beam pass through it in one direction only, that is, the forward direction, while dramatically suppressing the light propagating in the other, backward, direction.

Present polarization-independent optical isolators are typically based on the magneto-optical Faraday effect, which causes the rotation of the polarization of the light traveling collinearly to the direction of magnetization or external magnetic field. The Faraday effect is known to be nonreciprocal. The main part of such an exemplary prior art fiber optic isolator consists of a Faraday crystal (for example, one of many iron garnet compositions), a hollow magnet and two birefringent crystals (for example, LiNbO₃). The Faraday crystal is placed inside the hollow magnet and between these two birefringent crystals. Collimated beams are usually required for optimum performance through the isolator assembly from both the forward and backward directions. Hence, in fiber optical assemblies, a fiber collimator comprising basically a fiber and a GRIN (graded index) lens is used at the input and output ends of the isolator assembly.

The forward-going beam from the input fiber, when passing through the first birefringent crystal, is divided by said crystal into two spatially separated beams (the ordinary and extraordinary beams with orthogonal polarization vectors, that is, the O-beam and the E-beam) due to the birefringence. After passing through the Faraday crystal and the second birefringent crystal, these two beams are paralleled to each other and fully collected by the second collimator. However, the O-beam and the E-beam of the backward-going beam emerging from the first birefringent crystal, become divergent due to the nonreciprocal Faraday effect. They cannot be collected by the first collimator. Thus, the function of an isolator (to suppress the backward-going beam) is realized. The structure of such an isolator is quite complicated, and accurate optical alignments between these parts are required. The high cost of the core materials and labor leads to a relatively expensive isolator. In addition, the Faraday coefficient in the Iron Garnets and other magneto-optical materials is known to be wavelength dependent (i.e., dispersion takes place). This limits the wavelength range where a prior art isolator can work well to a 20-40 nm band (although the center of said band may vary over a wide range (from 900 nm to 1700 nm) depending on isolator parameters), which is detrimental because of the much wider wavelength ranges used now in optical communications and other applications.

In some prior art magneto-optical elements, the performance is strongly affected by the alignment of the incident beam with respect to the plate normal direction and by the divergence of the incident beam, thus requiring a high price and expensive alignment and collimation of the beam in prior art optical isolator.

There is therefore a need for another type of fiber optic isolator that significantly reduces the number of components, resulting in a simpler structure, a faster assembly time, lower cost, higher reliability and improved performance.

Non-limiting illustrative exemplary implementations provide a novel new optical isolator, which provides a sufficient level of light isolation for a wider range of angles and wavelengths, and which permits large area optical isolators to be realized. Non-limiting illustrative exemplary implementations also provide a cost-effective and large scale production-compatible method for the fabrication of such optical isolators.

Non-limiting illustrative exemplary implementations of the technology herein also provide a new retroreflection suppression plate design, which suppresses the retroreflection from optical components and/or systems, while avoiding drawbacks. Non-limiting illustrative exemplary implementations also provide cost-effective and large scale production compatible methods of fabrication of such a retroreflection suppression plate.

Non-limiting illustrative exemplary implementations further provide a novel type of light scattering/diffusing plate, which provides uniform scattering and/or diffusion of light, and a cost-effective and large scale production-compatible method for the fabrication of such light scattering/diffusing plates.

A plate having leaky waveguides defined therethrough can be used for retroreflection suppression and/or light diffusing/optical isolation. Such designs can exhibit good performance over a wider range of wavelengths and angles of the incident light than current art optical components. One example of the retroreflection suppression plate may define a plurality of spatially disordered transmission channels in the form of decoupled leaky waveguides co-linear with the light beam. Light transmission takes place only or primarily through channels through reflection from the reflective channel walls. In the far field, the light reflected by such a plate will be uniformly scattered into a wide cone. An example of an optical isolator is a plate composed of a plurality of spatially ordered transmission channels in the form of decoupled leaky waveguides with channel diameters modulated asymmetrically in the direction along the pore axes, and with the leaky waveguide walls coated with at least one layer of metal. The non-reciprocity of such a plate is realized through the no reciprocity of the transmission losses through each leaky waveguide, which in turn is caused by an asymmetric variation of the leaky waveguide cross-sections in the axial direction. Light coupled into the plate from one side passes through the plate, while light coupled from the other side of the plate is scattered and eventually absorbed, thus providing the desired no reciprocity. An improved optical diffusing system for diffusing light uniformly over a predetermined angle with minimal backscattering losses may be realized with such a scattering plate providing a plurality of spatially disordered transmission channels in the form of decoupled leaky waveguides. Such plates may be fabricated by electrochemical etching of semiconductor material, and more particularly silicon, under conditions providing macropore layer formation with subsequent removal of the non-etched part of the wafer to open the pores at the second end. The pore walls can be further coated and/or filled with various dielectric or metallic coatings to provide or enhance the optical performance of such plates.

In non-limiting illustrative exemplary implementations, the retroreflection from the optical component and/or system may be strongly suppressed with no or with only minor changes in the transmitted intensity by covering the detector (a focal plane array {FPA} or any other detector known to those skilled in the art). This can be done for example by placing a special scattering plate sufficiently close to the detector (in the “near field”). Such a plate comprises a plurality of spatially disordered transmission channels in the form of decoupled leaky waveguides. In such a plate, the light transmission takes place only through the leaky waveguides, separated by reflective leaky waveguide walls. Light is coupled into the leaky waveguides at the first surface of the plate and outcoupled at the second surface. Due to random spacing of the transmission channels and random sizes of said channels (although the sizes may be within a fairly narrow range of values), the coherence of the light transmitted through such a plate will be lost. The outcoupling will be independent of the coupling process and will take place over all angles within the numerical aperture of said leaky waveguides.

This type of scattering plate suppresses scattering from the first surface of the plate. Scattering may for example be made less that 8% of the total light intensity incident on the plate if the plate is correctly constructed and the leaky waveguide ends are tapered. In the exemplary non-limiting illustrative implementations, scattering is not due to the independence of the coupling and outcoupling processes.

If, as a nonlimiting example, the retroreflection suppression plate of an exemplary non-limiting illustrative implementation is disposed on the surface of FPA, the retroreflection, which is very strong for Focal Plane Arrays, will be scattered in many directions, making it much less intense in any one direction. Taking into account the very large typical spacing between the detector array and the tracking means, the retroreflection signal will be effectively suppressed by wide scattering. Such a solution is very advantageous, since not only will the retroreflection be completely suppressed and the performance of the detector array will not be sacrificed, but also the plate will be very compact, rugged and lightweight, which is important for military and aerospace applications.

Further, an exemplary illustrative non-limiting method of manufacturing a retroreflection suppression plate starts with semiconductor material, e.g. macroporous silicon. Said macroporous silicon layer may be made through electrochemical or photo-electrochemical anodic etching of a single crystalline silicon wafer. The exemplary method of forming macroporous silicon layers include:
preparing the semiconductor wafer having first and second surfaces wherein said first surface is substantially flat, and
anodically etching the substrate wafer to produce a structured layer having pores with controlled depths defined at least partially therethrough.

The etching method may include connecting the substrate as an electrode, contacting the first surface of the substrate with an electrolyte, setting a current density (or voltage, depending on the type of semiconductor material used and type of doping of said semiconductor wafer used) that will influence etching erosion, and continuing the etching to form said pores extending to a desired depth substantially perpendicularly to said first surface.

According to the one aspect of the present implementation, the pores may be disposed randomly and no preparation of the first surface of the silicon wafer is needed.

According to another aspect of the present implementation, the pore position is predetermined. In this case, the pore growth is not “naturally” random, but randomly generated by a computer-made mask pattern, and pores nucleate at predetermined sites that are random or have any structure required by the design. In this case, preliminary depressions can be formed on the first surface of said wafer (etch pits) to control the locations of the pores to be formed in the electrochemical etching process. Said etch pits can be formed through the application of a photoresist layer on the first surface of the semiconductor wafer, photolithographically defying the pattern of openings and chemically or reactive ion etching the etch pits through said openings. Alternatively, said etch pits can be formed by depositing a material layer with different chemical properties than that of the substrate by means of chemical or physical vapor deposition, thermal oxidation, epitaxial growth, sol-gel coating or any other technique known to those skilled in the art. A further step may be the application of a photoresist layer on the top of said material, photolithographically defining the pattern of openings in the photoresist layer, transferring said patterns into said layer through chemical or reactive ion etching and transforming the resultant pattern into a corresponding etch pit pattern through chemical or reactive ion etching. Said layer of material with different chemical properties than that of the substrate wafer may then be removed through chemical etching, reactive ion etching or any other method known to those skilled in the art, or may not be removed. The electrolyte used in electrochemical etching can be an HF-based aqueous acidic electrolyte. Alternatively, the electrolyte can be an HF-based organic electrolyte. A second surface of the substrate wafer that lies opposite the first surface may be illuminated during electrochemical etching. One or more of the electrochemical process parameters such as current density, applied voltage, electrolyte temperature and/or illumination intensity (for n-doped Si wafers) can vary in a predetermined fashion during the pore growth process to provide the pores with needed variations in cross section. Said porous layer should be made than free-standing (i.e., pores are open at both surfaces of the wafer) by post-etch processing, such as reactive ion etching (RIE), chemical etching, mechanical or chemical-mechanical polishing. The pore walls may be left uncoated after the anodization, or, alternatively, they may be coated by one or more layers of metal to improve the performance of said plate. Said coating of the pore walls may be realized through an Atomic Layer Deposition (ALD) technique or a liquid deposition technique as may be well known to those skilled in the art. Alternatively, the pores may be completely filled by one or more materials transparent in the operational wavelength range of said plate to further improve the performance (to enlarge the acceptance angle of such a plate). More over, the first and second surfaces of said porous wafers may be coated by one or more layers of different materials as an antireflection coating. Said porous layer may be sealed between two plates of transparent materials to mechanically reinforce said plate and improve its environmental stability.

According to further exemplary non-limiting implementations, light diffusers may be realized with a scattering plate similar to a retroreflection suppression plate, described above. Such a plate comprises a plurality of spatially disordered transmission channels in the form of decoupled leaky waveguides. In such a plate, the light transmission takes place only through the leaky waveguides, separated optically and physically by a reflective host. Light is coupled into the leaky waveguides at the first surface of the plate and outcoupled at the second surface. Due to random spacing of the transmission channels and random sizes of said channels (although the sizes may be within fairly narrow range of values), the coherence of the light transmitted through such a plate will be completely lost, and the uniform scattering of light will take place in all angles within the numerical aperture of said leaky waveguides. Features of this exemplary type of scattering plate include, but are not limited to, the following:

1) in the case of the plate of the present implementation, the scattering occurs into some angle (determined by the numerical aperture of the leaky waveguides), thus making it possible to fully collect the light emitted by the surface and utilize it (for example in optical microscopy).

2) Retroreflection and scattering into the backward direction from the surfaces of the plate in the plate of exemplary non-limiting illustrative implementations may be made minimal (less that 8% total) if the plate is correctly constructed and the leaky waveguide ends are tapered.

3) The scattering pattern of the non-limiting illustrative implementation is not dependent on the convergence and tilt, due to the independence of the coupling and outcoupling processes.

According to one aspect of the exemplary non-limiting implementation, the light scattering/diffusing plate can be manufactured in a manner similar to that of the retroreflection suppression plate described above. According to the another aspect of the exemplary non-limiting implementation, the light scattering/diffusing plate can be fabricated through a replication by polymer casting from a replica, fabricated according to the method described above. Such a process is known to be very cost effective and a macroporous silicon-based plate, due to it's superior thermal and mechanical properties, should be well-suited for such applications. Still further, such a plate may be used for laser machining purposes.

According to a further non-limiting exemplary illustrative implementation, optical isolators may exhibit good performance over a wider range of wavelengths for some polarizations of the incident light if the nonreciprocal element is a plate comprising a plurality of spatially ordered transmission channels in the form of decoupled leaky waveguides having periodic, asymmetric coherent (i.e., variation along the depth is identical for all the leaky waveguides in an array) variation in cross-sections co-linear with the light beam. In such a plate, the light transmission takes place only through channels by means of reflection from the reflective channel walls. The nonreciprocity of such a plate is realized through the nonreciprocity of the transmission through each leaky waveguide, which in turn is caused by an asymmetric variation of the leaky waveguide cross-section along the axial direction and metal coverage of the channel walls. Light coupled into the plate from one side passes through the plate, while light coupled from the other side of the plate is eventually absorbed in the metal layer, thus providing the needed nonreciprocity. A leaky waveguide-based nonreciprocal plate does not require any external magnetic field (i.e., a magnetic field generated by a permanent magnet as in some prior designs) and requires much less optical components in fiber-optical assembly. Still another advantage of such a nonreciprocal plate is independence of the performance of said nonreciprocal plate on the angle of incidence of light on said plate and on the divergence or convergence of the beam incident on the plate. This advantageous feature is due to the fact that the nonreciprocal properties of such a plate are realized because the interaction of light and the plate while light is traveling through the leaky waveguide channels is independent of the coupling of the light into said channels. This is under the requirement that said leaky waveguides are mutually decoupled and the ratio of leaky waveguide length (the thickness of the whole plate) to leaky waveguide diameter exceeds some value which may be in the range of 10 to 5000 and preferably in the range of 50 to 200).

A factor determining the performance of such a nonreciprocal plate (i.e., the ratio of the transmission in the “pass” direction to the transmission in the “blocking” direction, hereinafter called the “blocking ratio”) is the type of modulation of the leaky waveguide cross-section. For example, this modulation may be characterized by the following parameters: Reflectivity of the leaky waveguide walls, angle of the tilt of the first slope of the modulation feature, angle of the tilt of the second slope of the modulation feature, period of modulation (if said modulation is periodical) and the overall length of the modulated channels. The asymmetry and interaction with metal walls causes splitting of the leaky waveguide loss coefficient dependence, thus causing the occurrence of the nonreciprocity. The greater the difference, the stronger the splitting (utilizing the same period of modulation) and the smaller the length of the modulation needed to get the desired blocking ratio. Said modulation of the channel cross-section may be periodical with a constant period. Alternatively, it may be pseudo-periodical with period slowly changing in a predetermined fashion. The diameter modulation may be a periodical as well. The period of modulation may be in the range of 10 nm to 1 mm but preferably in the range of 200 nm to 100 μm.

According to a further aspect of an exemplary illustrative non-limiting implementation, such a nonreciprocal plate may be fabricated from a semiconductor material by means of electrochemical or photo-electrochemical etching (here collectively called “anodic etching”) of said semiconductor material. Said semiconductor material may be chosen from the group consisting of silicon, and III-V semiconductor compounds (for example, GaAs or InP) with a subsequent coating of the pore walls by a thin metal layer (by using ALD as a nonlimiting example of deposition technique). Pores in this case serve as leaky waveguides. Asymmetric modulation of the pore diameters may be realized by temporal variation of one or more parameters during the anodic etching of the semiconductor layer. Said parameters may be one or more chosen from the group consisting of anodization current density, illumination intensity, illumination wavelength, temperature of the electrolyte, and/or applied voltage. Alternatively, the resistivity (doping density) of the semiconductor substrate may be made non-constant through the wafer and said variations of the pore cross-sections may be realized with all or most of the above-listed parameters kept constant. Such a pore array can be made ordered by prestructuring of the first surface of the semiconductor wafer. Said porous member should be made free-standing (i.e., pores are open at both surfaces of the wafer) by post-etch processing, such as Reactive Ion Etching, chemical etching, or mechanical or chemical-mechanical polishing. The pore walls may be coated by one or more layers of dielectric or semiconductor materials to improve the performance of the nonreciprocal plate. The pores can be completely filled by one or more materials that are transparent in the operational wavelength range of said nonreciprocal plate in order to further improve the performance by means of increase in the acceptance angle. Said porous layer may be sealed between two plates of the transparent material to mechanically reinforce said plate and improve its environmental stability.

### BRIEF DESCRIPTION OF THE DRAWINGS

These and other features and advantages will be better and more completely understood by referring to the following detailed description in connection with the drawings, of which:

FIG. 1a is an illustrative exemplary non-limiting SEM image of the bottom surface of a random macroporous silicon array;

FIG. 1b is an illustrative schematic cross sectional view of a Focal Plane Array contiguous with a retroreflection suppression plate comprising a plurality of randomly spaced transmission channels or leaky waveguides;

FIG. 1c is a graph illustrating the spectral performance of the exemplary retroreflection suppression plate;

FIG. 2 is an exemplary diagrammatic view of the light scattering/diffusing plate;

FIG. 3a is a schematic illustrative view of an exemplary optical isolator incorporating an array of parallel coherent decoupled leaky waveguides having periodic asymmetric variation in cross-sections; and

FIG. 3b is a schematic illustrative cross-sectional view of array of parallel coherent decoupled leaky waveguides with periodic asymmetric variation in cross-sections.

### DETAILED DESCRIPTION OF ILLUSTRATIVE EXEMPLARY IMPLEMENTATIONS

Exemplary Illustrative Non-Limiting Retroreflection Suppression Plate Implementations

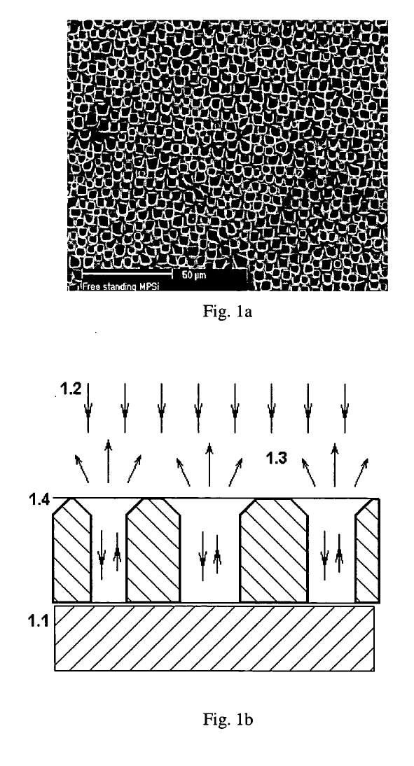

According to an exemplary illustrative non-limiting implementation, the retroreflection suppression plate comprises a plurality of spatially disordered transmission channels in the form of a decoupled leaky waveguides. Such a plate can be realized in a form of random macroporous silicon array, an SEM image of which is shown in FIG. 1a. In such a plate, the light transmission takes place only through the leaky waveguides, separated by reflective host. Light is coupled into the leaky waveguides at the first surface of the plate and outcoupled at the second surface. Due to random spacing of the transmission channels and random sizes of said channels (although the sizes may be within a fairly narrow range of values), the coherence of the light transmitted through such a plate will be completely lost. The outcoupling will be completely independent of the coupling process and will take place over all angles within the numerical aperture of said leaky waveguides. The differ

Features of this exemplary type of scattering plate include but are not limited to the following:

1) In the case of the plate of the present implementation, the scattering occurs into an angle determined by the numerical aperture of the leaky waveguides or waveguides, thus making it possible to fully collect the light emitted by the surface of the plate.

2) Retroreflection and retro-scattering in the plate of the presently preferred exemplary implementation may be made minimal (less that 8% total) if the plate is correctly constructed and the leaky waveguide ends are tapered.

3) The scattering pattern of the plate of the presently preferred exemplary implementation is not due to the independence of the coupling and outcoupling processes.

An illustrative cross sectional drawing of the detector array 1.1 with retroreflection plate 1.4 placed very near the top of said array is given in FIG. 1b. The incoming beam 1.2 and scattered beam 1.3 are also shown. The important requirement is that the pore (or leaky waveguide) cross-section should be less than the array's sensor element (pixel) size and that the detector array should be sufficiently close to the scattering plate (in the “near field”). In this case, the collimated retroreflection, which is very strong with, for example, uncooled infrared Focal Plane Arrays (as shown in FIG. 1b), will be scattered in many directions. In a nonlimiting example of the FPA with an inter-pixel spacing of 25 μm oriented to work in the long infrared spectral range (8 to 12 μm wavelength), the leaky waveguides should have the cross-section in the range of 8 to 20 μm, length in the range of 200 to 1000 μm and the FPA-to-retroreflection plate distance should not exceed ˜25 μm. Taking into account the very large spacing between the detector array and the tracking means, the retroreflected signal will be effectively suppressed by wide scattering. In addition, such a plate will have uniform, optimized performance over a wide range of wavelengths. Such a solution is very advantageous since not only will the retroreflection be strongly suppressed and the performance of the detector array will not be sacrificed, but also the plate will be very compact, rugged and lightweight, which is important for military and aerospace applications.

Exemplary Fabrication Method

Such an exemplary plate can be realized for example on the basis of porous semiconductors, and more specifically macroporous silicon. Said porous semiconductor may be made by means of electrochemical or photo-electrochemical anodic etching of a silicon wafer. In order to insure good near-field transmission through the plate, the pore walls should be straight and smooth. As was described above, the randomness of the pore array is essential for such a plate. Random pore arrays may be obtained by self-organization (i.e., without any pre patterning), so the pores nucleate according to the internally random anodization process. Alternatively, random pore arrays may be made by using preliminary prestructuring of the first surface of the silicon wafer. Thus, the pore growth is not “naturally” random, but randomly generated by computer-made mask pattern, and pores nucleate at predetermined sites that are random or have any structure required by the design. Said porous members may be made free-standing (i.e., pores are open at both surfaces of the wafer) by post-processing, such as reactive ion etching (RIE), chemical etching, or mechanical or chemical-mechanical polishing.

Electrochemical etching of silicon takes place in an electrochemical etching cell that can have several modifications according to the type of the electrochemical process used.

One exemplary illustrative, non-limiting method of fabrication of the retroreflection suppression plate will be disclosed based on the example of anodic etching of silicon. According to one exemplary implementation, a host wafer, or substrate of n-doped, single-crystal (100) oriented silicon having an electrical conductivity of, for example, 0.1 to 5 Ω*cm is provided. Next, the first surface (with depressions) of the substrate is brought into contact with a fluoride-containing, acidic electrolyte. The electrolyte has a hydrofluoric acid concentration in the range of 0.5% to 50%, and preferably in the range of 2-8%. A surfactant can be added to the electrolyte in order to suppress the development of hydrogen bubbles on the first surface of the substrate during the etching process.

The substrate wafer is then connected as an anode. A voltage in a range of 0 volts through 100 volts (0.5 to 10 volts preferably) is applied between the substrate wafer and the electrolyte. The substrate wafer is illuminated with a light on from the backside of the wafer so that a current density of, for example, 10 mA/cm², is set or obtained. In general, the current density is preferably set within the range of 4 mA/cm² through 20 mA/cm². The pores will be formed to extend perpendicularly to the first surface of the host wafer. The electrochemical etching produces the holes, also known as macropores. A macroporous layer is thus formed in the host wafer starting from the first surface.

Alternatively, substrate wafer can be of p-doped, single-crystal (100)-oriented silicon having an electrical conductivity of, for example, 1 to 200 Ω*cm. The difference with the n-doped case disclosed above will be an electrolyte composition that should necessarily contain organic additives to promote macropore formation during the electrochemical etching process. For the case of electrical conductivity of the p-doped Si wafer in the range of 1 to 10 Ω*cm, the electrolyte should contain a hydrofluoric acid concentration in the range of 0.5% to 50% HF by volume, and preferably in the range of 2-8%, and dimethylformamide (DMF) with a concentration in the range of 10 to 97%, and preferably in the range of 40 to 97% by volume. For the case of electrical conductivity of the p-doped Si wafer 11 being in the range of 10 to 100 Ω*cm, the electrolyte should contain a hydrofluoric acid concentration in the range of 0.5% to 50%, and preferably in the range of 2-8%. It should also contain acetonitrile (MeCN), diemethyl sulfoxide (DMSO) or DMF with a concentration in the range of 10 to 97%, and preferably in the range of 40 to 97%. Other organic additives, which serve as macropore promoters, known to those skilled in the art, can be used instead of DMF, DMSO or MeCN. In addition to said macropore-promoting organic additives, the electrolyte can contain wetting agent, similar in function to one disclosed previously for the n-type Si case.

In both implementations disclosed above, the electrochemical etching is performed during the time required to form a macroporous layer with a thickness predetermined by the retroreflection suppression plate design considerations. This time can be found before the filter process begins by means of calibration runs.

According to another exemplary implementation, the electrochemical etching process parameters (such as, for example, current density or backside illumination intensity) can be changed during an etching run such that tapered pore ends are formed on both the first surface of the Si wafer and near the deep ends of the pores. This can be accomplished, for example, by setting an initial current density of 3 mA/cm² (directly for p-doped Si and by means of the illumination intensity for n-doped Si), linearly changing it to 8 mA/cm during first 20 minutes of the etching process, setting the process parameters to obtain pores with the needed depth and profile, and then linearly changing the current density down to 3 mA/cm² during the last 20 minutes. The examples given herein do not preclude other changes of electrochemical parameters that can be performed. After the electrochemical etching process is complete, the Si wafer having macropores is removed from the electrochemical etching apparatus.

Next, the portion of the silicon wafer not having the MPSi layer, but within the overall pattern boundaries, is removed. Removal of the said portion of wafer can be done by, for example, alkaline etching of the bulk silicon from the second surface of silicon wafer until the MPSi layer is reached. The etching can be done in, for example, a 40% by weight KOH water solution at a temperature of in the range of 70 to 90° C., but preferably 75° to 80° C. Alternatively, removal of said non-porous portion of the wafer can be accomplished by, for example, the acidic etching of the second surface of silicon wafer until the MPSi layer is reached. According to a further implementation, removal of said portion of wafer can be done by, for example, the mechanical grinding and polishing of the second surface of silicon wafer until the MPSi layer is reached. According to a still further exemplary implementation, removing of said portion of wafer can be done by, for example, the chemical-mechanical polishing of the second surface of silicon wafer until the MPSi layer is reached. In accordance to still another implementation, the removal of said portion of wafer can be done by, for example, reactive ion etching. It should be noted that mechanical or chemical-mechanical polishing of the second surface of said wafer can be required even after most of said portion of wafer is removed by any of the aforementioned means in order to achieve the necessary optical flatness of the second surface of the final retroreflection suppression plate. It should also be noted that polishing of the first surface of said wafer can also be required at times in order to achieve the necessary flatness of the first surface of the final retroreflection suppression plate. According to a further implementation, the removal of said portion of wafer can be done particularly by Reactive Ion Etching or Deep Reactive Ion Etching.

If, for a particular retroreflection suppression plate design, neither pore filling by transparent material nor pore wall coverage by a metal layer is required, the retroreflection suppression plate fabrication will completed at this stage. If metal coating of the pore walls is needed by the application, it can be accomplished by a Chemical Vapor Deposition technique or the Atomic Layer Deposition technique. If pore filling by a transparent material is required by a particular application in order to enlarge the acceptance angle of the plate, additional fabrication steps are needed. According to one illustrative implementation, said pore filling can be accomplished by the Chemical Vapor Deposition technique or Atomic Layer Deposition technique. Alternatively, said transparent material can be applied as a thick (70% to 95% of pore radius) coating of the pore walls rather that as a complete filling.

Using the fabrication steps provided above, a retroreflection suppression plate for visible and ultraviolet spectral ranges has been fabricated and optically tested. In this example, neither pore wall coating nor pore filling was used. The spectral dependences of the near-field transmission through such a plate and of the retroreflection at ˜20 cm (a mirror under the plate was used as a reflective surface) are given in FIG. 1c. One can see that substantial suppression of the retroreflection over a very wide spectral range was obtained, while a good level of near field transmission was retained.

Exemplary Illustrative Light Diffusion Implementations

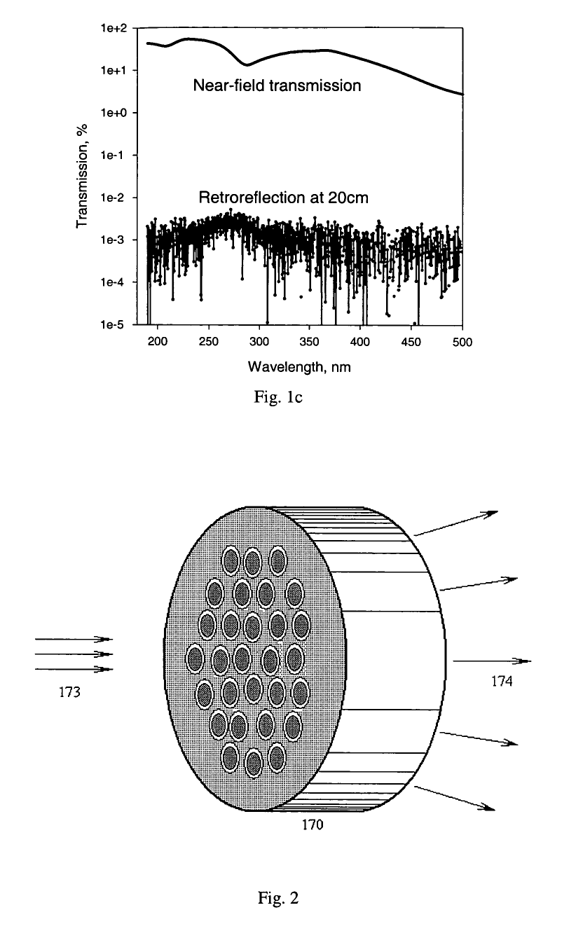

According to a further exemplary implementation, light scatterers/diffusers can be realized with a plate similar to the retroreflection suppression plate disclosed in relation to the first implementation of the presently preferred exemplary implementation. The diagrammatic illustrative drawing of the light scattering/diffusing plate of the presently preferred exemplary implementation is given in FIG. 2. According to a further aspect of the present implementation, light scattering/diffusing a plate 170 comprises a plurality of spatially disordered transmission channels in the form of decoupled leaky waveguides. In such a plate, the light transmission takes place only through the leaky waveguide modes. Light 173 is coupled into the leaky waveguides at the first surface of the plate and outcoupled at the second surface to the light beam 174. Due to random spacing of the transmission channels and random sizes of said channels (although the sizes may be within fairly narrow range of values), the coherence of the light transmitted through such a plate 170 will be completely lost, and the uniform scattering of light will take place in all angles within the numerical aperture of said leaky waveguides. Features of this type of scattering plate include, but are not limited to, the following:

1) In the case of the plate of the present implementation, the scattering occurs into a limited angle (determined by the numerical aperture of the leaky waveguides), thus making it possible to fully collect the light emitted by the surface and utilize it (for example in optical microscopy).

2) Retroreflection and scattering from the first surface of the plate in the plate of the presently preferred non-limiting exemplary implementation can be made minimal (less that 8% total) if the plate is correctly constructed and the leaky waveguide ends are tapered.

3) The scattering pattern of the plate of the presently preferred non-limiting exemplary implementation is not dependent on incident beam convergence and tilt, due to the independence of the coupling and outcoupling processes.

Light scattering/diffusing plates of the present arrangement can be fabricated following the fabrication sequence disclosed above.

Example Illustrative Non-Limiting Optical Isolators

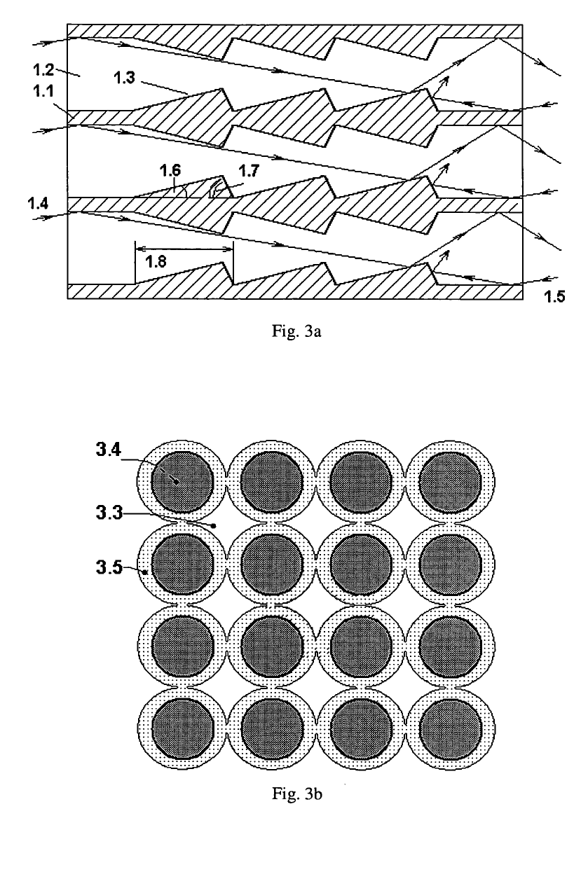

According to a further non-limiting exemplary implementation, optical isolators can be realized on the basis of the nonreciprocal element in the form of a plate comprising a plurality of spatially ordered transmission channels in the form of decoupled leaky waveguides having periodic asymmetric variation in cross-sections that are co-linear with the light beam and channel walls that are coated with a metal layer. An illustrative schematic view of such a plate cross-section is given in FIG. 3a. In such a plate, the light transmission takes place only through channels 1.2 through reflection from the reflective channel walls 1.1. The nonreciprocity of such a plate is realized through the nonreciprocity of the transmission through each leaky waveguide, which in turn is caused by an asymmetric variation of the leaky waveguide cross-section 1.3. Said variation of the leaky waveguide cross-section can be made, for a nonlimiting example in a “saw-tooth” shape as shown in FIG. 3a. As schematically shown in FIG. 3a, light coupled into the plate from one side 1.4 passes through the plate, while light coupled from another side of the plate 1.5 is scattered and eventually absorbed in a metal layer coating the leaky waveguide walls, thus providing the needed nonreciprocity. A schematic illustrative cross-sectional view of array of parallel coherent decoupled leaky waveguides with periodic asymmetric variation in cross-sections is given in FIG. 3b. It consists of the host 3.3, metal layer 3.5 and leaky waveguide core 3.4, which can be either air- or vacuum-filled, or can be filled with transparent dielectric material to increase the acceptance angle of the nonreciprocal plate. It should be noted that the ordering of the leaky waveguides is essential to preserve spatial coherence of light passing through the plate. Although FIG. 3b gives a drawing of a square-symmetry leaky waveguide array, the possible symmetry of all possible arrays is by no means limited by such a symmetry, and can be hexagonal or of more complex nature.

A particular advantage of such an exemplary plate design is that such a plate may be adjusted to operate over a wide range of wavelengths from the visible spectral range to mid infrared (1R) spectral range by choosing the correct leaky waveguide diameter, leaky waveguide structure and metal layer parameters. In addition, a leaky waveguide nonreciprocal plate of presently preferred non-limiting exemplary implementation does not require any external magnetic field (i.e., a magnetic field generated by a permanent magnet as described above). Still another advantage of such a nonreciprocal plate is independence of the performance of said nonreciprocal plate on the angle of incidence of light on said plate and on the divergence or convergence of the beam incident on the plate. This advantageous feature is due to the fact that the nonreciprocal properties of such a plate are realized because the interaction of the light traveling through the leaky waveguide mode within the plate is independent of the coupling of the light into said mode. This is under the requirement that said leaky waveguides are mutually decoupled and the ratio of leaky waveguide length (the thickness of the whole plate) to leaky waveguide diameter exceeds a significant value, which may be in the range of 10 to 5000 and preferably in the range of 50 to 200.

The overall transmission through such a plate in the forward direction (i.e., in the “pass” direction) is governed by several parameters including, but not limited to, the coupling efficiency of light on the first surface of the plate, the outcoupling efficiency on the second surface of the plate, channel size, cross-section, reflectivity of the channel walls, filling material of the channel (if any), and type of asymmetric channel modulation. The coupling efficiency for a plate having unfilled (i.e., air- or vacuum-filled) channels is proportional to the “porosity” of such a plate near the first interface. “Porosity” is understood to be the ratio of the average total area of the channels to the area of the plate. If tapering of the channels is realized (i.e., gradual increase of the channel cross-section from the value away from the surface to the value at the surface) as high as 90% coupling efficiency may be in principle realized while keeping said nonreciprocal plate mechanically robust. The main factor determining the performance of such a nonreciprocal plate (i.e., the ratio of the transmission in the “pass” direction to the transmission in the “blocking” direction, hereinafter called the “blocking ratio”) is the type of modulation of the leaky waveguide cross-section. For example, this modulation can be characterized by the following parameters: Reflectivity of the leaky waveguide walls, angle of the tilt of the first slope of the modulation feature 1.6, angle of the tilt of the second slope of the modulation feature 1.7, period of modulation (if said modulation is periodical) 1.8 and the overall length of the modulated channels. The difference in 1.7 and 1.6 dimensions (i.e., asymmetry) causes splitting of the leaky waveguide loss coefficient dependence, thus causing the occurrence of the nonreciprocity. The greater the difference, the stronger the splitting (utilizing the same period of modulation) and the smaller the length of the modulation needed to get the desired blocking ratio. Said modulation of the leaky waveguide cross-section may be periodical with a constant period 1.8. Alternatively, it may be pseudo-periodical with period slowly changing in a predetermined fashion (the angles 1.6 and 1.7 change slowly as well). The diameter modulation may be aperiodical as well. The period of modulation may be in the range of 10 nm to 50 μm but preferably in the range of 200 nm to 10 μm.

Example Illustrative Non-Limiting Fabrication

Such a nonreciprocal plate may be realized in several ways. However, we believe that the most convenient and cost-effective design would include the fabrication of such a plate based on porous semiconductor material. Said semiconductor material may be porous silicon made through the so-called electrochemical or photo-electrochemical etching of the single-crystalline silicon wafer in a process similar to one disclosed above. Asymmetric modulation of the pore diameters may be realized by temporal variation of one or more parameters during the anodic etching. Said parameters may be one or more chosen from the group consisting of anodization current density, illumination intensity, illumination wavelength, temperature of the electrolyte, and/or applied voltage. Alternatively, the resistivity (doping density) of the silicon substrate may be made non-constant through the wafer and said variations of the pore cross-sections may be realized with all or most of the above-listed parameters kept constant.

Alternatively, said semiconductor material may be chosen from III-V compound semiconductors, for example GaAs or In. Anodic etching in this case should be performed in a similar manner to silicon anodic etching disclosed in relation to the first implementation of the presently preferred non-limiting exemplary implementation except for the electrolyte composition, which should contain HCl, H₂SO₄ or H₃PO₄ acids diluted with water. Wetting agents and other additives can be used as well.

It should be noted that such a nonreciprocal plate could be used in both fiber optic and volume (i.e., free-space) optic applications. Since no external magnetic field is needed for such a nonreciprocal plate, the size of the plate is limited only by the sizes of the substrates and thus may be made as large as 200 mm in diameter.

While the technology herein has been described in connection with what is presently considered to be the most practical and preferred implementations, it is to be understood that the invention is not to be limited to the disclosed exemplary illustrative non-limiting implementations.

1. A light scattering plate comprising:
a substrate or host wafer having a first and a second surface and further including plural substantially uniform, parallel, uncoupled leaky waveguides defined at least partially therethrough, the plural leaky waveguides defining axes that are substantially perpendicular to the wafer first surface, the plural leaky waveguides each supporting at least one waveguide mode in a predetermined spectral range

2. A light scattering plate of claim 1 wherein said host wafer at least partially comprises porous semiconductor material, said pores in the semiconductor host serving as leaky waveguides while the host semiconductor material optically and physically separates neighboring leaky waveguides.

3. A light scattering plate of claim 2 wherein said semiconductor material is macroporous silicon.

4. A light scattering plate of claim 1, wherein the wafer has a thickness of from about 10 to about 5000 times the characteristic lateral dimension of the leaky waveguides.

5. A light scattering plate of claim 1 wherein at least one layer of highly reflective material is made to coat the leaky waveguide walls.

6. A light scattering plate of claim 5, wherein the said at least one layer of the reflective leaky waveguide wall coating is made of a metal.

7. A light scattering plate of claim 1, wherein centers of said leaky waveguides are spaced apart by a distance in the range of 0.5 μm to 30 μm, said distance being more than the smallest lateral dimension of said leaky waveguides.

8. A light scattering plate of claim 1, wherein said leaky waveguides are spatially disordered in the plane of said wafer.

9. A light scattering plate of claim 1, wherein said leaky waveguides are disposed in a pattern that has a complex order having complex symmetry.

10. A light scattering plate of claim 1, wherein said leaky waveguides have at least one end tapered near a first or second wafer surface.

11. A light scattering plate of claim 10 wherein said tapering is created such that the leaky waveguide cross section is gradually increased when approaching said waveguide end with the rate of increase being in the range of 1 to 55 degrees with respect to the leaky waveguide axis.

12. A light scattering plate of claim 1 wherein said wafer is disposed between two plates of material that are transparent in a predetermined spectral range.

13. A light scattering plate of claim 1 wherein said host wafer at least partially comprises porous semiconductor material, with pore walls coated by a substantially transparent material, said coated pores comprise the cores of said leaky waveguides and said semiconductor material between the pores optically and physically separates neighbor leaky waveguides.

14. A light scattering plate of claim 13 wherein said pore wall coating is comprised of multilayer of materials of differing indices of refraction.

15. A light scattering plate of claim 1 wherein said plate serves to suppress retroreflection of light from optical system over a broad spectral range.

16. A light scattering plate of claim 15 wherein said plate is disposed contiguous to an optical detection means.

17. A light scattering plate of claim 1 wherein said plate serves as a light diffuser in a transmission mode.

18. A light scattering plate of claim 17 wherein and said diffuser provides substantially uniform scattering of light over a range of angles within the numerical aperture of the leaky waveguides.

19. A light scattering plate of claim 17 wherein said leaky waveguides have both ends tapered to maximize the transmission through said light diffusing element.

20. An optical isolation component for transmitting light propagating in a first direction and absorbing light propagating in the opposite direction, within at least some spectral band comprising:
a substrate or host wafer having a first and a second surface and further including plural, substantially uniform, parallel, uncoupled leaky waveguides defined at least partially therethrough, the plural leaky waveguides having axes that are substantially perpendicular to the wafer first surface, the plural leaky waveguides each supporting at least one waveguide mode in a predetermined spectral range, the plural waveguides having coherently asymmetrically modulated cross-sections along the directions of the axes over at least some part of the length of said waveguides.

21. An optical isolation component of claim 20 wherein said host wafer at least partially comprises porous semiconductor material, said pores in the semiconductor host serving as leaky waveguides while the host semiconductor material optically and physically separates neighboring leaky waveguides.

22. An optical isolation component of claim 21 wherein said semiconductor material is macroporous silicon.

23. An optical isolation component of claim 22 wherein said semiconductor material is porous III-V compound semiconductor.

24. An optical isolation component of claim 23 wherein said porous Ill-V compound semiconductor is chosen from the group consisting of porous GaAs and porous, InP.

25. An optical isolation component of claim 20, wherein the wafer has a thickness of from about 10 to about 5000 times the characteristic lateral dimension of the leaky waveguides.

26. An optical isolation component of claim 20 wherein at least one layer of metal is made to coat the leaky waveguide walls.

27. An optical isolation component of claim 26 wherein said metal is chosen from the group consisting of Au, Ag, Al and Cu.

28. An optical isolation component of claim 26 wherein at least one layer of transparent dielectric material is disposed over the metal layer coating the leaky waveguide walls.

29. An optical isolation component of claim 20, wherein centers of said leaky waveguides are placed apart by a distance in the range of 0.5 μm to 30 μm, said distance being more than the smallest lateral dimension of said leaky waveguides.

30. An optical isolation component of claim 20, wherein said leaky waveguides are spatially ordered in the plane of said wafer.

31. An optical isolation component of claim 30, wherein said symmetry is hexagonal symmetry.

32. An optical isolation component of claim 30, wherein said symmetry is cubic symmetry.

33. An optical isolation component of claim 30, wherein said leaky waveguides are disposed such that the leaky waveguide pattern has a complex order having complex symmetry.

34. An optical isolation component of claim 20, wherein said leaky waveguides have at least one end tapered at one wafer first or second surface.

35. An optical isolation component of claim 34 wherein said tapering is created such that the leaky waveguide cross section is gradually increased when approaching said leaky waveguide end with the rate of increase being in the range of 1 to 55 degrees with respect to the leaky waveguide axis.

36. An optical isolation component of claim 20, wherein said asymmetrical modulation is made in the form of saw-tooth.

37. An optical isolation component of claim 20, wherein said leaky waveguide cross-section modulation is periodic, with a period from about 50 nm to about 20 μm.

38. An optical isolation component of claim 20, wherein said leaky waveguide cross section modulation is a superposition of two or more periodic modulations, each modulation with a period from about 50 nm to about 20 μm.

39. An optical isolation component of claim 20, wherein said modulation is quasi-periodic with the period changing along the depth of said leaky waveguides in a predetermined fashion.

40. An optical isolation component of claim 20, wherein said leaky waveguides have more than one length segment of modulation along their depth.

41. An optical isolation component of claim 20 wherein said wafer is disposed between two plates of materials that are transparent in a predetermined spectral range.

42. A method of making a light scattering plate comprising:
providing a substrate wafer of (100)-oriented single-crystal silicon having a first surface and a second surface,
electrochemically etching the substrate wafer to produce a structured layer having pores with controlled depths defined at least partially therethrough,
removing at least one un-etched portion of the substrate wafer, and
coating the pore walls with at least one metal layer, said material having a thickness of at least 10 nm.

43. The method of claim 42 further including the method of providing the first surface of the substrate wafer, prior to electrochemical etching, with a surface topology that defines the cross-sectional shape, arrangement and location of the pores to be formed during etching.

44. The method of claim 43, wherein said surface topology is composed of depressions on the first surface of substrate wafer.

45. The method of claim 43, wherein said surface topology is produced by:
disposing upon said wafer surface at least one layer of a material with different chemical properties than those of said substrate wafer material, by producing a photoresist mask on the surface of said layer, by etching away the said layer material inside said photoresist mask openings, by further etching the wafer surface through said formed openings in said disposed chemically different material and by further removal of said chemically different layer from the first surface of the wafer after the formation of said surface topology.

46. The method of claim 42 wherein said etching is obtained by electrochemical means and includes connecting the substrate as an electrode, contacting the first surface of the substrate with an fluoride-containing, acidic electrolyte, setting a current density that will influence etching erosion, and continuing etching to form said pores extending to a desired depth substantially perpendicular to said first surface.

47. The method of claim 46, wherein said electrolyte contains hydrofluoric acid in a range of 1% to 50% by volume.

48. The method of claim 42, wherein said silicon wafer is an n-type doped wafer and electrochemical etching includes illuminating a second surface of the substrate wafer that lies opposite the first surface during electrochemical etching.

49. The method of claim 42, wherein said silicon wafer is a p-type doped wafer and electrochemical etching occurs in an electrolyte additionally containing at least one organic additive selected from the group consisted of acetonitrile, dimethylformamide, dimethylsulfoxide, diethyleneglycol, formamide, hexamethylphosphoric triamide, isopropanol, triethanolamine, 2-methoxyethyl ether, triethylphosphite, and triethyleneglycol dimethyl ether.

50. The method of claim 42, wherein removal of the unwanted, unetched remainder of the wafer comprises a step selected from the group consisting of Reactive Ion Etching, chemical etching, and mechanical or chemical-mechanical polishing.

51. The method of claim 42, wherein said at least one metal layer is deposited by an atomic layer deposition technique.

52. The method of claim 42, further including substantially filling the pores with a transparent material after coating the pore walls with a said at least one layer of metal.

53. The method of claim 42 further including sealing said light scattering plate with two flat plates of materials that are transparent within the transparency range of said light scattering plate.

54. A method of making an optical isolation component comprising:
providing a semiconductor wafer substrate having a first surface and a second surface,
electrochemically etching the substrate wafer to produce a structured layer having pores with controlled depths and coherently, modulated diameters defined at least partially therethrough, and
coating the pores with at least one metal layer, said metal layer having a thickness of at least 10 nm.

55. The method of claim 54 further including a step prior to electrochemical etching of providing the first surface of the substrate wafer with a surface topology that defines the cross-sectional shape, arrangement and location of the pores to be formed during etching.

56. The method of claim 55, wherein said surface topology is composed of depressions on the first surface of substrate wafer.

57. The method of claim 55, wherein said surface topology is produced by:
disposing on the first surface of substrate wafer a layer of material with different chemical properties than those of the wafer material, by producing a photoresist mask on the surface of said layer, by etching away the said layer material inside the photoresist mask openings, by etching the wafer surface through the openings formed in said disposed chemically different material and by the removal of said chemically different layer from the first surface of the wafer after forming said surface topology.

58. The method of claim 54 wherein said etching is by electrochemical means and includes connecting the substrate as an electrode, contacting the first surface of the substrate with an acidic electrolyte, setting a current density that will influence etching erosion, and continuing etching to form said pores extending to a desired depth substantially perpendicular to said first surface.

59. The method of claim 57, wherein said substrate wafer is (100) oriented silicon and said electrolyte contains hydrofluoric acid in a range of 1% to 50% by volume.

60. The method of claim 59, wherein said silicon wafer is an n-type doped wafer and electrochemical etching includes illuminating a second surface of the substrate wafer that lies opposite the first surface during electrochemical etching.

61. The method of claim 59, wherein said silicon wafer is a p-type doped wafer and electrochemical etching occurs in an electrolyte additionally containing at least one organic additive selected from the group consisted of acetonitrile, dimethylformamide, dimethylsulfoxide, diethyleneglycol, formamide, hexamethylphosphoric triamide, isopropanol, triethanolamine, 2-methoxyethyl ether, triethylphosphite, and triethyleneglycol dimethyl ether.

62. The method of claim 54 wherein said substrate wafer is of a III-V compound semiconductor material.

63. The method of claim 54, wherein at least one electrochemical etching parameter selected from the group consisting of electrical current density, electrolyte temperature and/or applied voltage is changed in a predetermined fashion with time during the electrochemical etching process to provide the desired pore diameter modulation.

64. The method of claim 54, wherein said at least one metal layer is deposited by an atomic layer deposition technique.

65. The method of claim 55, further including coating the pore walls with at least one transparent material after coating the pores with a said at least one layer of metal.

66. The method of claim 65 wherein said coating is accomplished by a process selected from the group consisting of Chemical Vapor Deposition and Atomic Layer Deposition, electroplating and electroless plating.

67. The method of claim 54 further including sealing said optical isolation component with two flat plates of materials that are transparent within the transparency range of said optical isolation component.
